(19) United States
(12) Patent Application Publication
(10) Pub. No.: US 2026/0266611 A1
(43) Pub. Date: Sep. 10, 2026

(54) LOCATOR APPARATUS AND IN-VEHICLE SYSTEM

(71) Applicant: SUBARU CORPORATION, Tokyo (JP)

(72) Inventor: Akitaka OKO, Tokyo (JP)

(21) Appl. No.: 19/665,436

(22) Filed: May 1, 2026

Related U.S. Application Data
(63) Continuation of application No. PCT/JP2023/042043, filed on Nov. 22, 2023.

(51) Int. Cl. G01C 21/20

(52) U.S. Cl. CPC G01C 21/20

(57) ABSTRACT

A locator apparatus configured to be applied to a vehicle includes first processing circuitry and first communication circuitry. The first processing circuitry is configured to generate traveling road data and conversion data, based on a map database in which map data is stored in advance. The traveling road data is represented as a vehicle coordinate system relative to the vehicle and includes data indicating a location of a traveling road in a partial region set relative to the vehicle in a direction in which the vehicle is likely to travel. The conversion data is usable for coordinate conversion from the vehicle coordinate system into an absolute coordinate system. The first communication circuitry is configured to transmit time-series data of the traveling road data and time-series data of the conversion data.

### CROSS REFERENCE TO RELATED APPLICATIONS

This application is continuation of International Application No. PCT/JP2023/042043, filed on Nov. 22, 2023, the entire contents of which are hereby incorporated by reference.

### BACKGROUND

The disclosure relates to a locator apparatus and an in-vehicle system that are each to be mounted in a vehicle.

Some vehicles perform driver assistance based on high-precision map data. For example, Japanese Unexamined Patent Application Publication No. 2022-108069 discloses a technique of generating, with a locator apparatus, map data on a region in the vicinity of a vehicle and transmitting the generated map data to an automated driving controller.

### SUMMARY

An aspect of the disclosure provides a locator apparatus configured to be applied to a vehicle. The locator apparatus includes first processing circuitry and first communication circuitry. The first processing circuitry is configured to generate traveling road data and conversion data, based on a map database in which map data is stored in advance. The traveling road data is represented as a vehicle coordinate system relative to the vehicle and includes data indicating a location of a traveling road in a partial region. The partial region is set relative to the vehicle in a direction in which the vehicle is likely to travel. The conversion data is usable for coordinate conversion from the vehicle coordinate system into an absolute coordinate system. The first communication circuitry is configured to transmit time-series data of the traveling road data and time-series data of the conversion data.

An aspect of the disclosure provides an in-vehicle system including a locator apparatus and a processing apparatus. The locator apparatus includes first processing circuitry and first communication circuitry. The first processing circuitry is configured to generate traveling road data and conversion data, based on a map database in which map data is stored in advance. The traveling road data is represented as a vehicle coordinate system relative to the vehicle and includes data indicating a location of a traveling road in a partial region. The partial region is set relative to the vehicle in a direction in which the vehicle is likely to travel. The conversion data is usable for coordinate conversion from the vehicle coordinate system into an absolute coordinate system. The first communication circuitry is configured to transmit time-series data of the traveling road data and time-series data of the conversion data. The processing apparatus includes second communication circuitry and second processing circuitry. The second communication circuitry is configured to receive the time-series data of the traveling road data and the time-series data of the conversion data. The second processing circuitry is configured to restore the location of the traveling road on the absolute coordinate system, based on the time-series data of the traveling road data and the time-series data of the conversion data.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure. FIG. 1 is an explanatory diagram illustrating a configuration example of a vehicle including a driver assistance system that includes a locator apparatus and a processing apparatus according to one example embodiment of the disclosure.

FIG. 2 is a block diagram illustrating a configuration example of the driver assistance system illustrated in FIG. 1.

FIGS. 3A and 3B are an explanatory diagram illustrating an exemplary operation of the locator apparatus illustrated in FIG. 1.

FIGS. 4A and 4B are another explanatory diagram illustrating an exemplary operation of the locator apparatus illustrated in FIG. 1.

FIGS. 5A and 5B are another explanatory diagram illustrating an exemplary operation of the locator apparatus illustrated in FIG. 1.

FIG. 6 is another explanatory diagram illustrating an exemplary operation of the locator apparatus illustrated in FIG. 1.

FIG. 7 is an explanatory diagram illustrating an exemplary operation of a driver assistance apparatus illustrated in FIG. 1.

FIGS. 8A and 8B are an explanatory diagram illustrating an exemplary operation of a locator apparatus according to a reference example.

FIG. 9 is an explanatory diagram illustrating an exemplary operation of a locator apparatus according to a modification example.

### DETAILED DESCRIPTION

It is desired to transmit traveling road data covering a wide area including a region in the vicinity of a vehicle and also a region distant from the vehicle, from a locator apparatus to a post-stage apparatus. Further, in such a data transmission, it is expected to reduce the amount of communication data in the transmission.

It is desirable to provide a locator apparatus and an in-vehicle system that each make it possible to transmit and receive traveling road data covering a wide region while reducing the amount of communication data.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### EXAMPLE EMBODIMENTS

### Configuration Example

FIG. 1 illustrates a configuration example of a driver assistance system 10 that includes a locator apparatus and a processing apparatus according to an example embodiment of the disclosure. The driver assistance system 10 may be mounted in a vehicle 1, and may be configured to assist a driver in driving the vehicle 1, based on map data stored in a high-precision map database. The driver assistance system 10 may include an imaging apparatus 11, a global navigation satellite system (GNSS) antenna 12, a locator apparatus 20, and a driver assistance apparatus 30. The imaging apparatus 11, the locator apparatus 20, and the driver assistance apparatus 30 may be coupled to a communication bus BUS.

The imaging apparatus 11 may be configured to generate a captured image by capturing an image of an environment in front of the vehicle 1. The imaging apparatus 11 may be a monocular camera or a stereo camera. The imaging apparatus 11 may include a lens and an image sensor. In this example, the imaging apparatus 11 may be disposed inside the vehicle 1 and near an upper portion of a windshield of the vehicle 1. The imaging apparatus 11 may sequentially perform an imaging operation at an imaging timing corresponding to a predetermined frame rate (e.g., 10 [fps]) to thereby generate a series of captured images. Thereafter, the imaging apparatus 11 may transmit image data on the captured images thus generated to the driver assistance apparatus 30 via the communication bus BUS.

The GNSS antenna 12 may be configured to receive signals transmitted from the satellites of the GNSS such as the global positioning system (GPS).

The locator apparatus 20 may be configured to detect a position of the vehicle 1 on an absolute coordinate system, based on the signals received at the GNSS antenna 12, and generate various kinds of data necessary for the driver assistance, based on a result of detection of the position of the vehicle 1. The locator apparatus 20 may include a GNSS receiver 21, a processor 22, a storage 23, and a communicator 24.

The GNSS receiver 21 may be configured to detect the position of the vehicle 1 on the absolute coordinate system, based on the signals received at the GNSS antenna 12.

The processor 22 may include, for example, one or more processors and one or more memories, and may be configured to generate traveling road data DT and differential position data E. The traveling road data DT may include data indicating a location of a traveling road on which the vehicle 1 is likely to travel. The differential position data E may include data indicating a difference in position and direction of the vehicle 1 between two imaging timings different from each other.

In some embodiments, the processor 22 may set, at each imaging timing, a partial region R relative to the vehicle 1 in a direction in which the vehicle 1 is likely to travel. Further, the processor 22 may generate the traveling road data DT including the data indicating the location of the traveling road in the partial region R, based on the high-precision map database DB stored in the storage 23. The traveling road data DT may be represented as a vehicle coordinate system relative to the vehicle 1. Note that the traveling road data DT may include various kinds of data such as data indicating the position and content of a road sign on the traveling road, in addition to the data indicating the location of the traveling road.

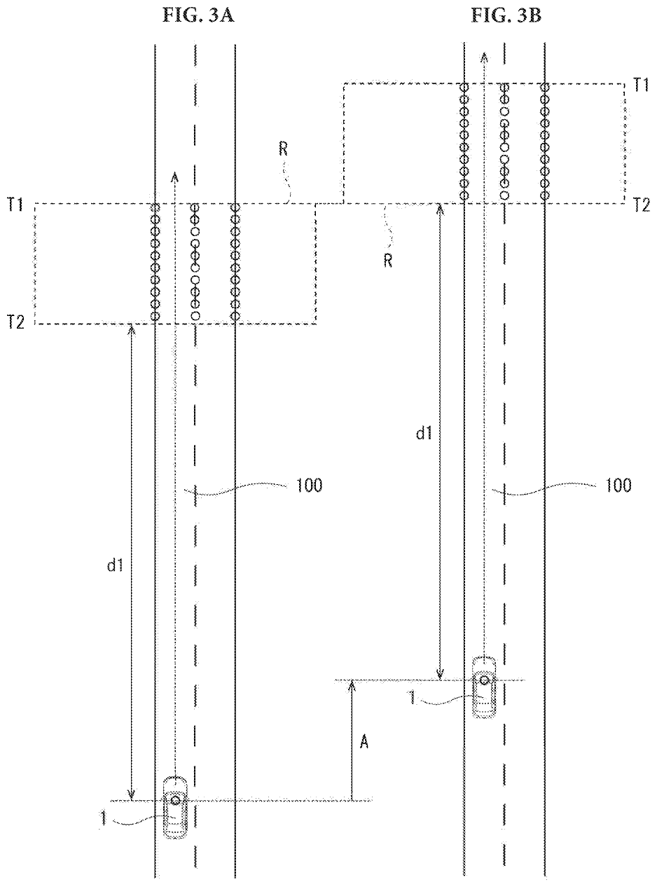

FIGS. 3A and 3B illustrates an example of the partial region R set by the processor 22. FIG. 3A illustrates the location of the partial region R set at a certain imaging timing, and FIG. 3B illustrates the location of the partial region R set at an imaging timing subsequent to the imaging timing illustrated in FIG. 3A. In this example, the vehicle 1 may travel on a traveling road 100. A description in this example is given of the case where drivers of vehicles keep to the left by driving on a left lane of the traveling road 100; however, this is non-limiting. In the case where drivers keep to the right by driving on a right lane of the traveling road 100, left and right settings or the like may be appropriately set in an opposite manner.

In this example, as illustrated in FIG. 3A, the processor 22 may set, at a certain imaging timing, the partial region R at a position ahead of the vehicle 1 and distant from the imaging apparatus 11 of the vehicle 1 by a distance d1. In an extending direction of the traveling road 100 (i.e., a longitudinal direction of FIGS. 3A and 3B), a frontal end of the partial region R may be positioned at a position T1, and a rear end of the partial region R may be positioned at a position T2. The processor 22 may generate the traveling road data DT including the data indicating the location of the traveling road in the partial region R, based on the high-precision map database DB stored in the storage 23. In this example, the data indicating the location of the traveling road may be data in which a lane dividing line of the traveling road 100 is represented as a dot sequence. The position of the dot sequence may be represented as the vehicle coordinate system. The locator apparatus 20 may transmit the traveling road data DT to the driver assistance apparatus 30 via the communication bus BUS.

As illustrated in FIG. 3B, the vehicle 1 may move forward in a distance A from the position at the previous imaging timing illustrated in FIG. 3A to a position at a subsequent imaging timing. As in the case illustrated in FIG. 3A, the processor 22 may set the partial region R at the location ahead of the vehicle 1 and distant from the imaging apparatus 11 of the vehicle 1 by the distance d1. The processor 22 may generate the traveling road data DT including the data indicating the location of the traveling road in the partial region R, based on the high-precision map database DB stored in the storage 23. Further, the locator apparatus 20 may transmit the traveling road data DT to the driver assistance apparatus 30 via the communication bus BUS.

The position T1 of the frontal end of the partial region R illustrated in FIG. 3A may be substantially aligned with the position T2 of the rear end of the partial region R illustrated in FIG. 3B. That is, the partial region R illustrated in FIG. 3A and the partial region R illustrated in FIG. 3B may not be separated from each other and not overlapped with each other in the extending direction of the traveling road 100. In such a manner, the processor 22 may set these two partial regions R at the respective imaging timings adjacent to each other such that the partial regions R are not separated from each other and not overlapped with each other. This allows the driver assistance system 10 to transmit the data indicating the location of the traveling road from the locator apparatus 20 to the driver assistance apparatus 30 without waste and without omission. If these two partial regions R are separated from each other, for example, the data indicating the location of the traveling road can be partially missing. If these two partial regions R are overlapped with each other, for example, the data on the overlapped region can be transmitted and received twice, which results in a waste of data. However, according to the driver assistance system 10, the two partial regions R chronologically adjacent to each other may be set not to be separated from each other and not to be overlapped with each other. This allows the driver assistance system 10 to transmit and receive the data indicating the location of the traveling road without waste and without omission.

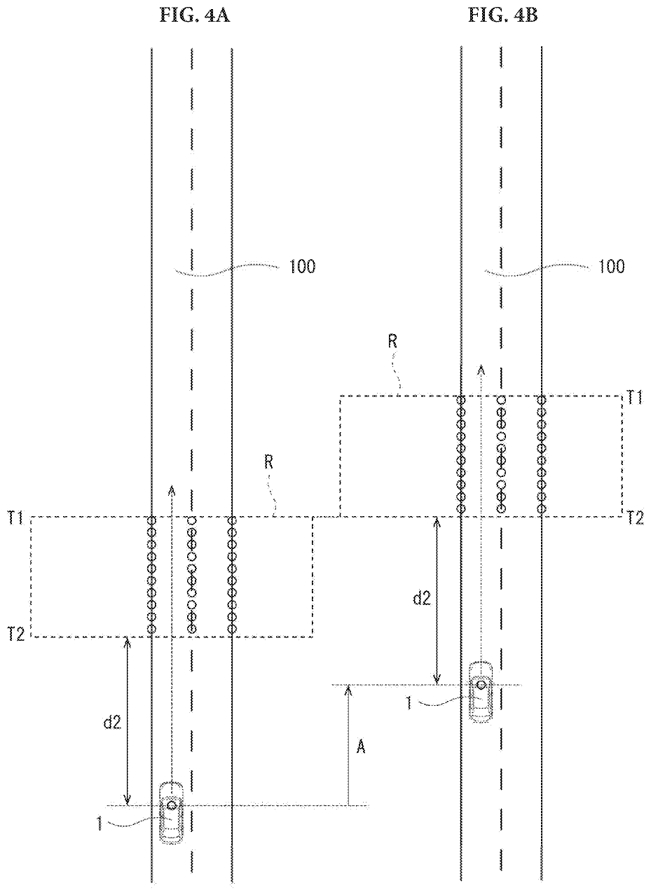

FIGS. 4A and 4B illustrates another example of the partial region R set by the processor 22. In this example, the amount of communication data to be transmitted via the communication bus BUS is too large to secure a sufficient amount of communication data to be transmitted from the processor 22 to the driver assistance apparatus 30. In such a case, it is necessary to reduce the data amount of the traveling road data DT; thus, the processor 22 may narrow the partial region R. In some embodiments, the processor 22 may shorten the length of the partial region R in the extending direction of the traveling road 100 (the longitudinal direction of FIGS. 4A and 4B), and the distance from the imaging apparatus 11 of the vehicle 1 to the partial region R may be gradually shorten accordingly. If such a situation is prolonged, the processor 22 may set the partial region R at a position ahead of the vehicle 1 and distant from the imaging apparatus 11 of the vehicle 1 by a distance d2 that is shorter than the distance d1, as illustrated in FIGS. 4A and 4B.

In this case also, the position T1 of the frontal end of the partial region R illustrated in FIG. 4A may be substantially aligned with the position T2 of the rear end of the partial region R illustrated in FIG. 4B. As described above, the processor 22 may set these two partial regions R at respective imaging timings adjacent to each other such that the partial regions R are not separated from each other and not overlapped with each other.

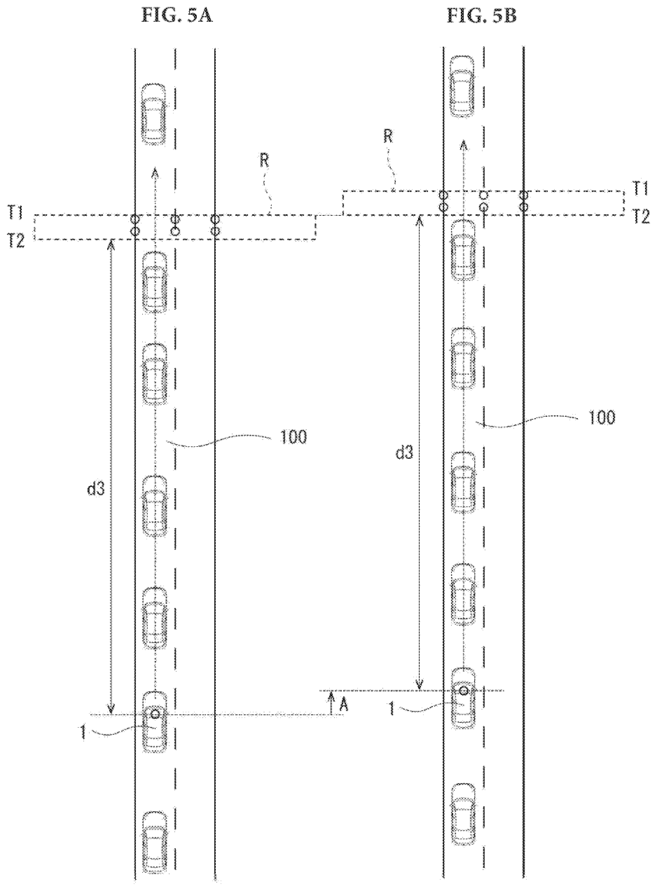

FIGS. 5A and 5B illustrates another example of the partial region R set by the processor 22. In this example, the lane of the traveling road 100 on which the vehicle 1 travels is congested. Thus, the vehicle 1 may move forward in a short distance A in a time period between two imaging timings adjacent to each other. In this case also, the position T1 of the frontal end of the partial region R illustrated in FIG. 5A may be substantially aligned with the position T2 of the rear end of the partial region R illustrated in FIG. 5B. The processor 22 may set two partial regions R at respective imaging timing adjacent to each other such that the partial regions are not separated from each other and not overlapped with each other by shortening the length of the partial region R in the extending direction of the traveling road 100 (i.e., the longitudinal direction FIGS. 5A and 5B). Further, the processor 22 may generate, at each imaging timing, the differential position data E including the data on the difference in position of the vehicle 1 between the current imaging timing and the previous imaging timing and the difference in direction of the vehicle 1 between the current imaging timing and the previous imaging timing.

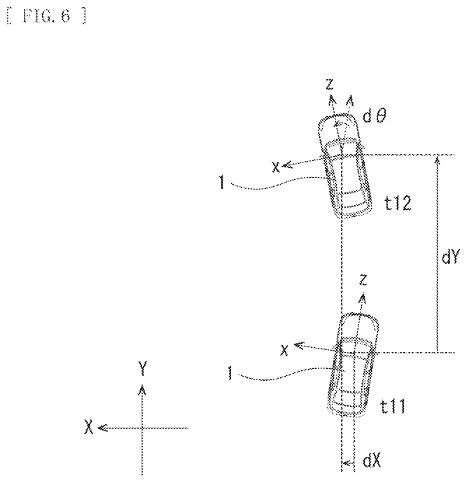

FIG. 6 illustrates an example of the differential position data E. The differential position data E may be represented as an absolute coordinate system based on the high-precision map database DB. The absolute coordinate system may be a coordinate system having an X-direction and a Y-direction. In contrast, the vehicle coordinate system may be a coordinate system having an x-direction and z-direction. The differential position data E may include three parameters dX, dY, and de. The parameter dX may be the difference in position of the vehicle 1 in the X-direction between two imaging timings t11 and t12, as illustrated in FIG. 6. The parameter dY may be the difference in position of the vehicle 1 in the Y-direction between the imaging timings t11 and t12, as illustrated in FIG. 6. The parameter do may be the difference in direction of the vehicle 1 between the imaging timings t11 and t12, as illustrated in FIG. 6.

As described above, the processor 22 may set the partial region R at each imaging timing, and generate the traveling road data DT including the data indicating the location of the traveling road in the partial region R, based on the high-precision map database DB. Further, the processor 22 may generate the differential position data E including the parameters dX, dY, and de at each imaging timing.

The storage 23 may include a non-volatile storage device such as a semiconductor memory and may be configured to store the high-precision map database DB.

The communicator 24 may be configured to transmit the traveling road data DT and the differential position data E generated by the processor 22 to the driver assistance apparatus 30 via the communication bus BUS.

The driver assistance apparatus 30 may be configured to assist the driver in driving the vehicle 1, based on the data transmitted from the imaging apparatus 11 and the locator apparatus 20. The driver assistance apparatus 30 may include a communicator 31 and a processor 32.

The communicator 31 may be configured to receive the image data on the captured image transmitted from the imaging apparatus 11 and the traveling road data DT and the differential position data E transmitted from the locator apparatus 20.

The processor 32 may include, for example, one or more processors and one or more memories. The processor 32 may be configured to perform processing based on the data received at the communicator 31 to thereby control an operation of the driver assistance system 10.

In some embodiments, the processor 32 may recognize an object, based on the image data on the captured image transmitted from the imaging apparatus 11, and perform the driver assistance, based on a result of recognition. For example, the processor 32 may control the operation of the driver assistance system 10 to cause the driver assistance system 10 to notify the driver of information on the object thus recognized.

Further, the processor 32 may restore the location of the traveling road on which the vehicle 1 is likely to travel, based on time-series data of the traveling road data DT transmitted from the locator apparatus 20 and time-series data of the differential position data E. Based on the restored location of the traveling road, the processor 32 may perform the driver assistance. In some embodiments, the processor 32 may control the operation of the driver assistance system 10 to cause the driver assistance system 10 to issue a notification to the driver or cause the driver assistance system 10 to perform deviation prevention control when the vehicle 1 is likely to deviate from the traveling lane.

In one embodiment, the locator apparatus 20 may serve as a “locator apparatus”. In one embodiment, the processor 22 may serve as “first processing circuitry”. In one embodiment, the high-precision map database DB may serve as a “map database”. In one embodiment, the traveling road data DT may serve as a “traveling road data”. In one embodiment, the differential position data E may serve as a “conversion data”. In one embodiment, the communicator 24 may serve as “first communication circuitry”. In one embodiment, the driver assistance apparatus 30 may serve as a “processing apparatus”. In one embodiment, the communicator 31 may serve as “second communication circuitry”. In one embodiment, the processor 32 may serve as “second processing circuitry”. In one embodiment, the driver assistance system 10 may serve as an “in-vehicle system”.

### [Operation and Effects]

A description will now be given of operation and effects of the driver assistance system 10 according to the present example embodiment.

### (Outline of Overall Operation)

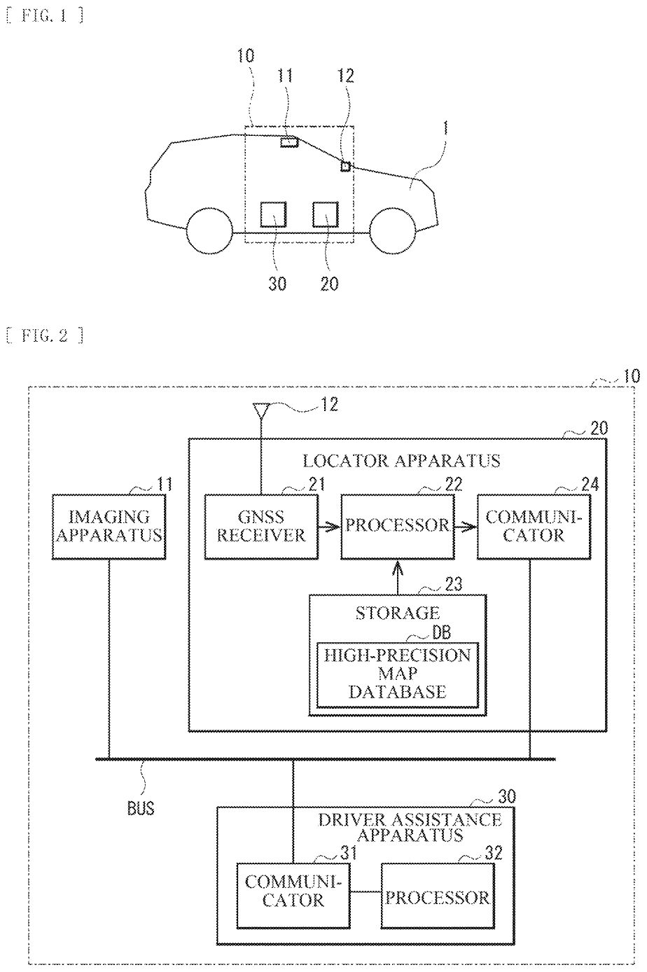

First, the operation of the driver assistance system 10 is described with reference to FIG. 2. The imaging apparatus 11 may generate a captured image by capturing an image of the environment in front of the vehicle 1 and transmit the image data on the captured image thus generated to the driver assistance apparatus 30 via the communication bus BUS. The GNSS antenna 12 may receive signals transmitted from the GNSS satellites such as the GPS. The locator apparatus 20 may detect the position of the vehicle 1 on the absolute coordinate system, based on the signals received at the GNSS antenna 12, and generate the traveling road data DT and the differential position data E, based on the result of detection of the position of the vehicle 1. Further, the locator apparatus 20 may transmit the traveling road data DT and the differential position data E to the driver assistance apparatus 30 via the communication bus BUS. The driver assistance apparatus 30 may assist the driver in driving the vehicle 1, based on the data transmitted from the imaging apparatus 11 and the locator apparatus 20. In some embodiments, the driver assistance apparatus 30 may recognize an object, based on the image data on the captured image transmitted from the imaging apparatus 11, and perform the driver assistance, based on the result of recognition. Further, the driver assistance apparatus 30 may restore the location of the traveling road on which the vehicle 1 is likely to travel, based on the traveling road data DT and the differential position data E transmitted from the locator apparatus 20. The processor 32 may perform the driver assistance, based on the restored location of the traveling road.

### (Details of Operation)

The processor 22 of the locator apparatus 20 may generate, at each imaging timing, the traveling road data DT, which includes the data indicating the location of the traveling road on which the vehicle 1 is likely to travel, and the differential position data E, which includes the data indicating the difference in position and direction of the vehicle 1 between two imaging timings different from each other. The communicator 24 of the locator apparatus 20 may transmit the traveling road data DT and the differential position data E to the driver assistance apparatus 30 via the communication bus BUS. The driver assistance apparatus 30 may restore the location of the traveling road on which the vehicle 1 is likely to travel, based on the time-series data of the traveling road data DT and the time-series data of the differential position data E transmitted from the locator apparatus 20.

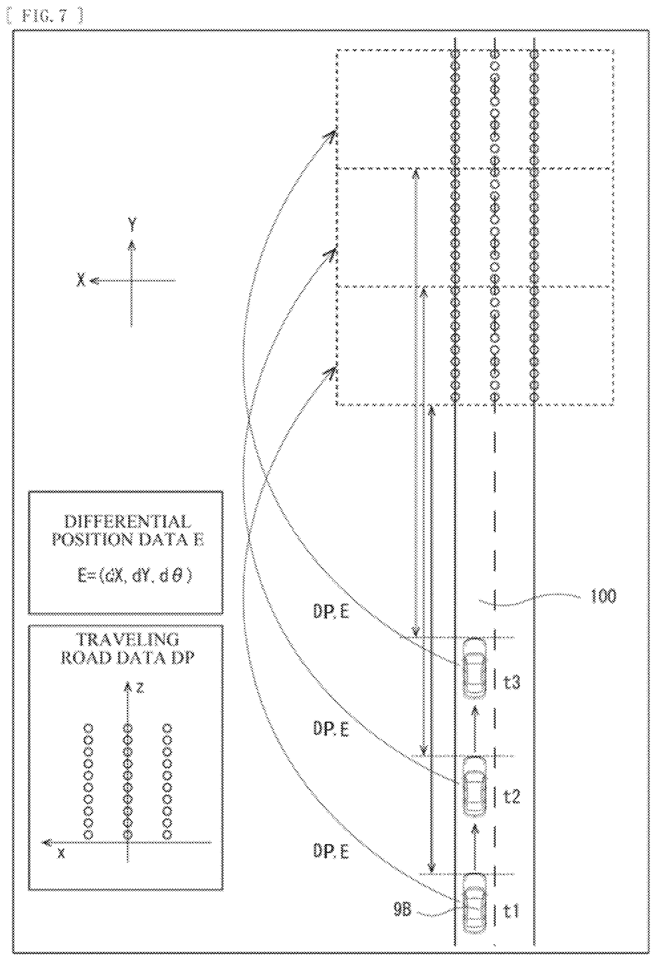

FIG. 7 illustrates an exemplary processing performed by the processor 32 of the driver assistance apparatus 30 to restore the location of the traveling road 100.

The processor 32 of the driver assistance apparatus 30 may arrange dot sequences indicating lane dividing lines included in the traveling road data DT on a plane of the absolute coordinate system, based on the traveling road data DT and the differential position data E acquired at the imaging timing t1, for example. The data on the positions of the dot sequences included in the traveling road data DT may be represented as the vehicle coordinate system. Accordingly, the processor 32 may convert the positions of the dot sequences on the vehicle coordinate system into the positions on the absolute coordinate system by performing coordinate conversion using the differential position data E.

As illustrated in FIG. 6, the differential position data E may indicate the difference in position and direction of the vehicle 1 between two imaging timings. Accordingly, the processor 32 may be configured to store a plurality of pieces of the past differential position data E, and calculate the difference in position and direction of the vehicle 1 between a past reference imaging timing and a current imaging timing, based on the plurality of pieces of the differential position data E. In some embodiments, the processor 32 may be configured to convert the position of the dot sequence on the vehicle coordinate system into the position on the absolute coordinate system, using the position and direction of the vehicle 1 on the absolute coordinate system at the reference imaging timing as an initial value.

Similarly, the processor 32 of the driver assistance apparatus 30 may arrange the dot sequences indicating the lane dividing lines included in the traveling road data DT on the plane of the absolute coordinate system, based on the traveling road data DT and the differential position data E acquired at the imaging timing t2, for example. Further, the processor 32 of the driver assistance apparatus 30 may arrange the dot sequences indicating the lane dividing lines included in the traveling road data DT on the plane of the absolute coordinate system, based on the traveling road data DT and the differential position data E acquired at the imaging timing t3, for example.

As described above, the processor 32 of the driver assistance apparatus 30 may sequentially arrange the dot sequences indicating the lane dividing lines on the absolute coordinate system, based on the time-series data of the traveling road data DT and the time-series data of the differential position data E to thereby restore the location of the traveling road 100. Further, the processor 32 may perform the driver assistance, based on the restored location of the traveling road 100.

As described above, the driver assistance system 10 includes the locator apparatus 20 and the processing apparatus (the driver assistance apparatus 30). The locator apparatus 20 includes the first processing circuitry (the processor 22) and the first communication circuitry (the communicator 24). The first processing circuitry is configured to generate the traveling road data DT and the conversion data (the differential position data E), based on the map database (the high-precision map database DB). The traveling road data DT is represented as the vehicle coordinate system relative to the vehicle 1 and includes the data indicating the location of the traveling road in the partial region R set in the direction in which the vehicle 1 is likely to travel relative to the vehicle 1. The conversion data is usable for the coordinate conversion from the vehicle coordinate system to the absolute coordinate system. The first communication circuitry is configured to transmit the time-series data of the traveling road data DT and the time-series data of the conversion data (the differential position data E). The processing apparatus (the driver assistance apparatus 30) includes the second communication circuitry (the communicator 31) and the second processing circuitry (the processor 32). The second communication circuitry is configured to receive the time-series data of the traveling road data DT and the time-series data of the conversion data (the differential position data E). The second processing circuitry is configured to restore the location of the traveling road on the absolute coordinate system, based on the time-series data of the traveling road data DT and the time-series data of the conversion data (the differential position data E). The driver assistance system 10 with such a configuration makes it possible to restore the location of the traveling road over a wide range, based on the time-series data of the traveling road data DT and the time-series data of the differential position data E, as illustrated in FIG. 7. It is therefore possible for the driver assistance system 10 to transmit and receive the traveling road data over a wide range while reducing the amount of communication data.

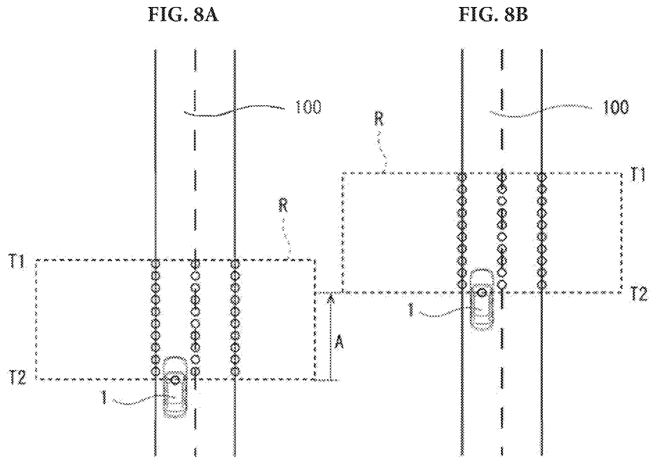

A driver assistance system according to a reference example which sets a predetermined partial region R including the vehicle 1 at each imaging timing as illustrated in FIGS. 8A and 8B, for example, is simply capable of transmitting and receiving the traveling road data over a narrow range. In other words, the amount of communication data to be transmitted via the communication bus BUS is limited, which results in difficulties in transmitting and receiving the traveling road data over a wide range. In such a case, the driver assistance system according to the reference example can have difficulties in performing the driver assistance when the vehicle 1 is traveling at a high traveling speed on a high way, for example. However, the driver assistance system 10 according to the present example embodiment is configured to transmit and receive the time-series data of the traveling road data DT and the time-series data of the differential position data E, which makes it possible to restore the location of the traveling road over a wide range, as illustrated in FIG. 7. It is therefore possible for the driver assistance system 10 to transmit and receive the traveling road data over a wide range while reducing the amount of communication data. As a result, the driver assistance system 10 makes it possible to easily perform the driver assistance even when the vehicle 1 is traveling at a high traveling speed, for example.

Further, according to the driver assistance system 10, the conversion data may include the differential position data E that is represented as the absolute coordinate system and indicates the difference in position and direction of the vehicle between two timings different from each other. Accordingly, it is possible for the driver assistance system 10 to reduce the data amount of the conversion data to be transmitted via the communication bus BUS. For example, if the conversion data includes conversion matrix data allowing for direct coordinate conversion from the vehicle coordinate system into the absolute coordinate system, the amount of communication data can be large. For instance, the amount of data relating to translation in the conversion matrix can be large. According to the driver assistance system 10 of the present example embodiment, the conversion data may include the differential position data E; therefore, the data on the difference in position and direction of the vehicle between two timings different from each other is to be simply transmitted and received, which makes it possible to reduce the amount of communication data. Further, according to the driver assistance system 10, the first processing circuitry (the processor 22) may be configured to generate the time-series data of the traveling road data DT by sequentially setting the partial regions R and generate the time-series data of the conversion data (the differential position data E). Further, the first processing circuitry (the processor 22) may be configured to set two chronologically adjacent ones of the partial regions not to be separated from each other and not to be overlapped with each other. This allows the driver assistance system 10 to transmit the data indicating the location of the traveling road without waste and without omission. If these two partial region R are separated from each other, for example, the data indicating the location of the traveling road can be partially missing. If these two partial regions R are overlapped with each other, for example, the transmission and reception of the data on the overlapped region can be conducted two times, which results in a waste of data. However, according to the driver assistance system 10, these two chronologically adjacent partial regions R may be set not to be separated from each other and not to be overlapped with each other. This allows the data indicating the location of the traveling road to be transmitted and received without waste and without omission.

### [Effects]

According to the example embodiment described above, the locator apparatus and the processing apparatus are provided. The locator apparatus includes the first processing circuitry and the first communication circuitry. The first processing circuitry is configured to generate the traveling road data and the conversion data, based on the map database. The traveling road data is represented as the vehicle coordinate system relative to the vehicle and includes the data indicating the location of the traveling road in the partial region set relative to the vehicle in the direction in which the vehicle is likely to travel. The conversion data is usable for the coordinate conversion from the vehicle coordinate system into the absolute coordinate system. The first communication circuitry is configured to transmit the time-series data of the traveling road and the time-series data of the conversion data. The processing apparatus includes the second communication circuitry and the second processing circuitry. The second communication circuitry is configured to receive the time-series data of the traveling road data and the time-series data of the conversion data. The second processing circuitry is configured to restore the location of the traveling road on the absolute coordinate system, based on the time-series data of the traveling road data and the time-series data of the conversion data. It is therefore possible to transmit and receive the traveling road data over a wide range while reducing the amount of communication data.

According to the present example embodiment, the conversion data may include the differential position data indicating the difference in position and direction of the vehicle between two timings different from each other. It is therefore possible to reduce the amount of communication data.

According to the present embodiment, the first processing circuitry may be configured to generate the time-series data of the traveling road data by sequentially setting the partial regions and generate the time-series data of the conversion data. The first processing circuitry may be further configured to set two chronologically adjacent ones of the partial regions not to be separated from each other and not to be overlapped with each other. This allows the data indicating the location of the traveling road to be transmitted and received without waste and without omission.

### Modification Example 1

In the example embodiment described above, the coordinate conversion from the vehicle coordinate system into the absolute coordinate system may be performed using the differential position data E indicating the difference in position and direction of the vehicle between two timings different from each other; however, this is non-limiting. According to Modification Example 1, the coordinate conversion from the vehicle coordinate system into the absolute coordinate system may be performed using conversion data including data on a conversion matrix allowing for the direct coordinate conversion from the vehicle coordinate system into the absolute coordinate system, for example. In such a case, the position of a dot sequence included in the traveling road data DT may be converted from the vehicle coordinate system into the absolute coordinate system using one piece of conversion data.

### Modification Example 2

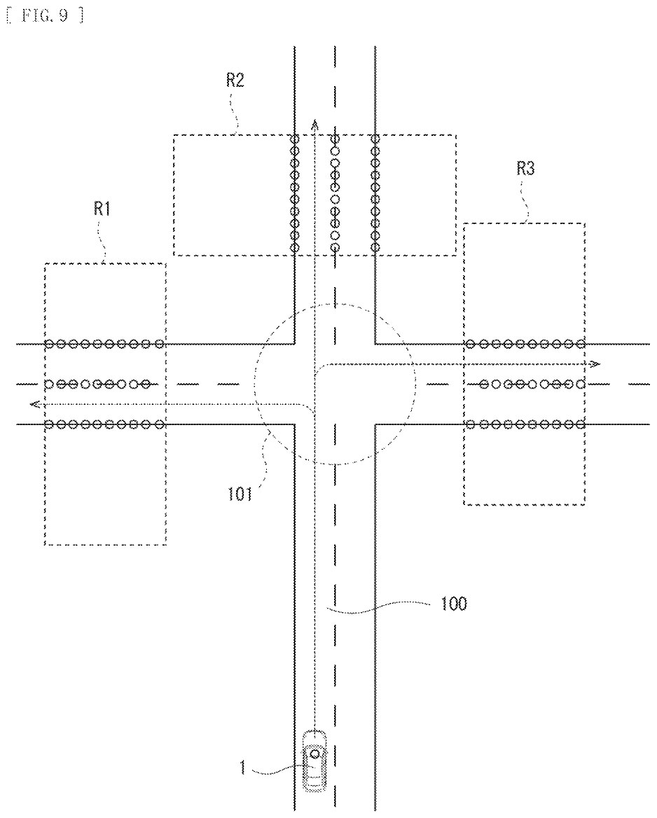

In the example embodiment described above, one piece of traveling road data DT may be transmitted or received at each timing; however, this is non-limiting. According to Modification Example 2, a plurality of pieces of traveling road data DT may be transmitted or received at each timing, as illustrated in FIG. 9, for example. In this example, an intersection 101 is located ahead of the vehicle 1 on the traveling road 100. The vehicle 1 may travel straight through the intersection 101 or turn left or right at the intersection 101. Accordingly, the processor 22 of the locator apparatus 20 may set three partial regions R1 to R3 in the respective directions in which the vehicle 1 is likely to travel. Further, the processor 22 may generate the traveling road data DT including the data indicating the location of a traveling road in each of the partial regions R1 to R3, based on the high-precision map database stored in the storage 23. The communicator 24 of the locator apparatus 20 may transmit the traveling road data DT and the differential position data E to the driver assistance apparatus 30 via the communication bus BUS.

In Modification Example 2, the three partial regions R may be set; however, this is non-limiting. When the vehicle 1 travels on a lane of the traveling road 100 for left turning at the intersection 101, for example, the processor 22 of the locator apparatus 20 may simply set the partial region R1. That is, in this case, the partial region R1 may be simply set because the vehicle 1 is likely to turn left at the intersection 101. Further, when a direction indicator of the vehicle 1 indicates that the vehicle 1 will turn left, the processor 22 may simply set the partial region R1.

### Modification Example 3

In the example embodiment described above, the processor 22 may generate the traveling road data DT including the data indicating the location of the traveling road in the partial region R, based on the high-precision map database DB stored in the storage 23; however, this is non-limiting. According to Modification Example 3, for example, the processor 22 may communicate with a server in which the high-precision map database DB is stored to thereby generate the traveling road data DT including the data indicating the location of the traveling road in the partial region, based on the high-precision map database DB stored in the server.

### Other Modification Examples

Any two or more these modification examples may be combined.

Although some embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, in the example embodiments described above, the locator apparatus 20 may transmit the traveling road data DT and the differential position data E at each imaging timing; however, this is non-limiting. Alternatively, the locator apparatus 20 may transmit the traveling road data DT and the differential position data E at every other imaging timing, for example. Still alternatively, the locator apparatus 20 may periodically transmit the traveling road data DT and the differential position data E at a timing different from the imaging timing, for example.

The effects described herein are mere examples, and effects of the disclosure are not limited thereto. Note that other effects of the disclosure may be obtainable.

Further, the disclosure may have the following configurations:
(1) A locator apparatus to be applied to a vehicle, the locator apparatus including:
   first processing circuitry configured to generate traveling road data and conversion data, based on a map database in which map data is stored in advance, the traveling road data being represented as a vehicle coordinate system relative to the vehicle and including data indicating a location of a traveling road in a partial region, the partial region being set relative to the vehicle in a direction in which the vehicle is likely to travel, the conversion data being usable for coordinate conversion from the vehicle coordinate system into an absolute coordinate system; and
   first communication circuitry configured to transmit time-series data of the traveling road data and time-series data of the conversion data.
(2) The locator apparatus according to (1), in which the conversion data includes differential position data that is represented as the absolute coordinate system and indicates a difference in position and direction of the vehicle between two timings different from each other.
(3) The locator apparatus according to (1) or (2), in which
   the first processing circuitry is configured to
generate the time-series data of the traveling road data by sequentially setting a plurality of the partial regions and generate the time-series data of the conversion data, and
   set two chronologically adjacent ones of the partial regions not to be separated from each other and not to be overlapped with each other.
(4) The locator apparatus according to any one of (1) to (3), in which the first processing circuitry is configured to change a distance from the vehicle to the partial region.
(5) The locator apparatus according to any one of (1) to (4), in which
   the first communication circuitry is configured to transmit the time-series data of the traveling road data and the time-series data of the conversion data, and
   the first processing circuitry is configured to change a size of the partial region, based on a degree of advancement of the vehicle between two adjacent timings in the time-series data.
(6) The locator apparatus according to any one of (1) to (5), in which
   the vehicle is likely to travel in multiple directions, and
   the partial region includes multiple partial regions corresponding to the multiple directions, respectively.
(7) A processing apparatus including:
   second communication circuitry configured to receive traveling road data and conversion data, the traveling road data being represented as a vehicle coordinate system relative to the vehicle and including data indicating a location of a traveling road in a partial region, the partial region being set relative to the vehicle in a direction in which the vehicle is likely to travel, the conversion data being usable for coordinate conversion from the vehicle coordinate system into an absolute coordinate system; and
   second processing circuitry configured to restore the location of the traveling road on the absolute coordinate system, based on time-series data of the traveling road data and time-series data of the conversion data.
(8) The processing apparatus according to (7), in which the second processing circuitry is configured to perform driver assistance control on the vehicle, based on the restored location of the traveling road.
(9) An in-vehicle system including:
   A Locator Apparatus Including
      first processing circuitry configured to generate traveling road data and conversion data, based on a map database in which map data is stored in advance, the traveling road data being is represented as a vehicle coordinate system relative to the vehicle and including data indicating a location of a traveling road in a partial region, the partial region being set relative to the vehicle in a direction in which the vehicle is likely to travel, the conversion data being usable for coordinate conversion from the vehicle coordinate system into an absolute coordinate system, and
      first communication circuitry configured to transmit time-series data of the traveling road data and time-series data of the conversion data; and
   a processing apparatus including
      second communication circuitry configured to receive the time-series data of the traveling road data and the time-series data of the conversion data, and
   second processing circuitry configured to restore the location of the traveling road on the absolute coordinate system, based on the time-series data of the traveling road data and the time-series data of the conversion data.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The term “substantially” and its variants having a similar meaning thereto are defined as being largely but not necessarily wholly what is specified as understood by one of ordinary skill in the art.

The term “disposed/provided in” and its variants having a similar meaning thereto as used herein refer to elements disposed directly in contact with each other or indirectly by having intervening structures therebetween.

The processor 22 illustrated in FIG. 2 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the processor 22 illustrated in FIG. 2. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the processor 22 illustrated in FIG. 2. This similarly applies to the processor 32 illustrated in FIG. 2.

1. A locator apparatus configured to be applied to a vehicle, the locator apparatus comprising:
first processing circuitry configured to generate traveling road data and conversion data, based on a map database in which map data is stored in advance, the traveling road data being represented as a vehicle coordinate system relative to the vehicle and comprising data indicating a location of a traveling road in a partial region, the partial region being set relative to the vehicle in a direction in which the vehicle is likely to travel, the conversion data being usable for coordinate conversion from the vehicle coordinate system into an absolute coordinate system; and
first communication circuitry configured to transmit time-series data of the traveling road data and time-series data of the conversion data.

2. The locator apparatus according to claim 1, wherein the conversion data comprises differential position data that is represented as the absolute coordinate system and indicates a difference in position and direction of the vehicle between two timings different from each other.

3. The locator apparatus according to claim 1, wherein
the partial region comprises a plurality of partial regions
the first processing circuitry is configured to
generate the time-series data of the traveling road data by sequentially setting the partial regions and generate the time-series data of the conversion data, and
set two chronologically adjacent ones of the partial regions not to be separated from each other and not to be overlapped with each other.

4. The locator apparatus according to claim 1, wherein the first processing circuitry is configured to change a distance from the vehicle to the partial region.

5. The locator apparatus according to claim 1, wherein
the first communication circuitry is configured to transmit the time-series data of the traveling road data and the time-series data of the conversion data, and
the first processing circuitry is configured to change a size of the partial region, based on a degree of advancement of the vehicle between two adjacent timings in the time-series data.

6. The locator apparatus according to claim 1, wherein
the vehicle is likely to travel in a plurality of directions, and
the partial region comprises partial regions corresponding to the directions, respectively.

7. An in-vehicle system comprising:
a locator apparatus comprising
first processing circuitry configured to generate traveling road data and conversion data, based on a map database in which map data is stored in advance, the traveling road data being represented as a vehicle coordinate system relative to the vehicle and comprising data indicating a location of a traveling road in a partial region, the partial region being set relative to the vehicle in a direction in which the vehicle is likely to travel, the conversion data being usable for coordinate conversion from the vehicle coordinate system into an absolute coordinate system, and
first communication circuitry configured to transmit time-series data of the traveling road data and time-series data of the conversion data; and
a processing apparatus comprising
second communication circuitry configured to receive the time-series data of the traveling road data and the time-series data of the conversion data, and
second processing circuitry configured to restore the location of the traveling road on the absolute coordinate system, based on the time-series data of the traveling road data and the time-series data of the conversion data.
